(19) United States
(12) Patent Application Publication
(10) Pub. No.: US 2006/0128406 A1
(43) Pub. Date: Jun. 15, 2006

(54) System, apparatus and method for detecting malicious traffic in a communications network

(76) Inventor: John William Forsyth Macartney, Edinburgh (GB)

Correspondence Address: Paul D. Greeley, Esq.;Ohlandt, Greeley, Ruggiero & Perle, L.L.P., 10th Floor, One Landmark Square, Stamford, CT, 06901-2682, US

(21) Appl. No.: 11/251,169

(22) Filed: Oct. 14, 2005

(30) Foreign Application Priority Data
Dec. 9, 2004 (GB) 0426971.8

(51) Int. Cl. H04Q 7/20

(52) U.S. Cl. 455/466

(57) ABSTRACT

Monitoring apparatus has a pattern matching engine that analyses service usage in a network in order to identify traffic relating to malicious attacks. Optionally, the monitoring apparatus can also arrange for a counter-measure to be deployed upon detection of the malicious traffic.

### 1. FIELD OF THE INVENTION

The present invention relates to a network monitoring apparatus for detecting malicious traffic of the type, for example, which monitors operation of a communications network that supports communications terminals, such as mobile data processing terminals. The malicious traffic can be, for example, of the type that uses processing resources of a communications terminal to propagate and/or proliferate illegitimate traffic through a communications network, for example traffic relating to a virus or a worm. The present invention also relates to a system comprising the apparatus for detecting the malicious traffic. The present invention further relates to a method of detecting malicious traffic in a communications network.

### 2. DISCUSSION OF THE BACKGROUND ART

The field of cellular telecommunications has evolved from its beginnings of simple voice communications to a mixture of voice and low-data rate communications. As data rates for mobile data communications have increased, particularly with the introduction of the General Packet Radio Service (GPRS) for Global Systems for Mobile communications (GSM) networks, the use of Internet-based applications with mobile devices has become more viable than before. Now, with the further introduction of third-generation (3G) cellular communications systems, for example the Universal Mobile Telecommunications System (UMTS), this viability is never more so.

With the introduction of the above high-speed data capabilities, portable communications devices, such as cellular telephones and Personal Digital Assistants (PDAs) have been developed to support applications that use these high-speed data capabilities, for example e-mail and web-browsing applications, as well as Java™ applications. In order to provide greater flexibility to the portable communications devices, the devices have become more software intensive to enable third parties, independent of the manufacturer of the devices, to create applications to be executed on the devices. This flexibility also allows the Internet-based applications to be continually improved by downloading updates onto the devices. However, it is this very flexibility that is also being exploited to launch malicious attacks, such as the propagation and proliferation of viruses and worms.

### SUMMARY OF THE INVENTION

According to a first aspect of the present invention, there is provided a network monitoring apparatus for detecting malicious traffic in a communications network, the apparatus comprising: an input for receiving service usage data derived, when in use, from signalling data, the signalling data originating, when in use, from a monitored signalling link; and a data store for storing the service usage data; and a processing resource to support a pattern matching engine for using a number of the stored data to identify, when in use, traffic patterns communicated to and/or from a communications terminal indicative of malicious traffic.

It should be appreciated that the above reference to service usage data refers to information associated with any service initiated and/or received, for example, details of an initiated and/or received Internet Protocol (IP) service. The details include one or more details of the initiator of the IP service or the recipient of the IP service. An example of such service usage data is a Service Usage Record (SUR), akin to a Call Detail Record, but relating to usage of IP services. For some embodiments, call data derived, when in use, from monitored signalling data associated with a voice telephony network or part of a network, may be employed. For the avoidance of doubt, service usage data embraces data derived in relation to voice telephony communications.

The data store may be any suitable mechanism for storing data, for example but not limited to, a memory device, such as an arrangement that maintains an electronic signal corresponding to data to be retained.

The service usage data may be a feed of Service Usage Records (SURs).

The data stored from the at least one field of received usage records may be stored as a database for serving as a resource for the identification of the traffic patterns.

The identification of the traffic patterns may include analysing a property of at least one field of at least one of the usage records.

The malicious traffic may correspond to a virus and/or a worm.

The processing resource may be arranged to generate, when in use, a message to indicate that malicious traffic has been detected. Indeed, the malicious traffic may correspond to a type of malicious attack, the message identifying the type of the malicious attack.

A counter-measure may be communicated, when in use, to the mobile terminal in response to the message.

A counter-measure may be initiated in relation to the communications terminal in response to the message. The counter-measure may be prevention of the communications terminal from using one or more service supported by the communications network associated with the communications terminal to communicate data.

The processing resource may be arranged to download pattern data for the pattern matching engine. The downloading of the pattern data may be periodic.

According to a second aspect of the present invention, there is provided a network monitoring system including the network monitoring apparatus as set forth above in relation to the first aspect of the present invention.

According to a third aspect of the present invention, there is provided a packet forwarding apparatus comprising the network monitoring apparatus as set forth above in relation to the first aspect of the present invention. The packet forwarding apparatus may be a router.

According to a fourth aspect of the present invention, there is provided a communications network comprising the apparatus as set forth above in relation to the first and/or third aspects of the present invention.

The network may further comprising a counter-measure service station for managing the deployment of the counter-measures.

According to a fifth aspect of the present invention, there is provided a method of detecting malicious traffic in a communications network, the method comprising: receiving a feed of service usage data derived from signalling data, the signalling data originating from a monitored signalling link; storing the service usage data; and using a number of the stored data to identify traffic patterns communicated to and/or from a communications terminal indicative of malicious traffic.

According to a sixth aspect of the present invention, there is provided a computer program element comprising computer program code means to make a computer execute the method as set forth above in relation to the fifth aspect of the present invention.

The computer program element may be embodied on a computer readable medium.

According to a seventh aspect of the present invention, there is provided a use of a communications network monitoring system to detect communications to and/or from wireless terminals indicative of a malicious attack.

It is thus possible to provide a method, apparatus and system for detecting malicious traffic that makes a communications network capable of detecting malicious attacks, such as viruses or worms. Additionally, proliferation of malicious attacks is reduced due to the centralised nature of the detection mechanism. In this respect, another benefit of centralised detection and counter-measure deployment is that the traffic patterns to be detected and the counter-measures are constantly current. This is in contrast to virus and worm detection and prevention software supported directly by mobile terminals, where the responsibility of keeping the software up-to-date rests with the owner of the communications terminals. Further, communications terminals, such as handsets, do not have to provide memory resources to support software for detecting malicious attacks. Of course, processing resources and hence battery life are therefore not consumed either.

### BRIEF DESCRIPTION OF THE DRAWINGS

At least one embodiment of the invention will now be described, by way of example only, with reference to the accompanying drawings, in which:

FIG. 1 is a schematic diagram of a network overview;

FIG. 2 is a schematic diagram of a network architecture shown in overview in FIG. 1;

FIG. 3 is a schematic diagram of an apparatus constituting an embodiment of the invention;

FIG. 4 is a schematic diagram of a pattern matching engine of FIG. 3;

FIG. 5 is a schematic diagram of a table for use by a pattern matching engine of FIG. 3;

FIGS. 6 and 7 are flow diagrams of a first pattern matching technique;

FIGS. 8 and 9 are flow diagrams of a second pattern matching technique; and

FIG. 10 is a schematic diagram of a third pattern matching technique.

### DETAILED DESCRIPTION OF THE PREFERRED EMBODIMENT

Throughout the following description identical reference numerals will be used to identify like parts.

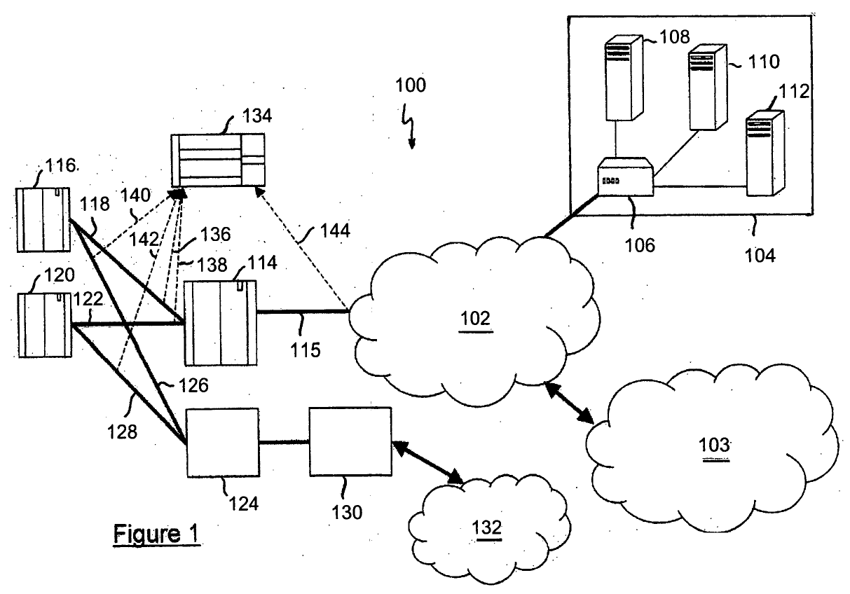

Referring to FIG. 1, a communications network 100 comprises an Internet Protocol (IP) backbone network 102, for example an Asynchronous Transfer Mode (ATM) or an Ethernet Local Area Network (LAN). The IP backbone network 102 is coupled to a public Internet 103 and Core Network Support Services 104. The Core Network Support Services 104 comprise, for example, a LAN switch 106 coupled to a node (not shown) in the IP backbone network 102, the LAN switch 106 also being coupled to a Domain Name System (DNS) server 110. For completeness, the LAN switch 106 is also coupled to a Remote Authentication Dial-In User Service (RADIUS) server 108 and a Dynamic Host Configuration Protocol (DHCP) server 112.

The IP backbone network 102 is also coupled to a Serving GPRS (General Packet Radio Service) Support Node (SGSN) 114 by a first link 115. In a first embodiment, the SGSN 114 is coupled to a UMTS (Universal Mobile Telecommunications System) Terrestrial Access Network (UTRAN) 116 by a second link 118. In a second embodiment, the SGSN 114 is coupled to a GSM/EDGE Radio Access Network (GERAN) 120 by a third link 122. Additionally, the UTRAN 116 and the GERAN 120 are coupled to a Mobile Switching Centre (MSC) 124 by a fourth link 126 and a fifth link 128, respectively. The MSC 124 is coupled to a Gateway MSC 130, the Gateway MSC 130 being coupled to a Public Switched Telephone Network (PSTN) 132.

In order to monitor traffic passing between the SGSN 114 and the UTRAN 116 and the GERAN 120, a probe 134 is coupled to the second and third links 118, 122 by a first tap 136 and a second tap 138, respectively. Similarly, in order to monitor traffic passing between the Gateway MSC 130 and the UTRAN 116 and the GERAN 120, the probe 134 is also coupled to the fourth and fifth links 126, 128 by a third tap 140 and a fourth tap 142, respectively. In order to monitor traffic between the SGSN 114 and the IP backbone network 102, a fifth tap 144 is coupled to the first link 115.

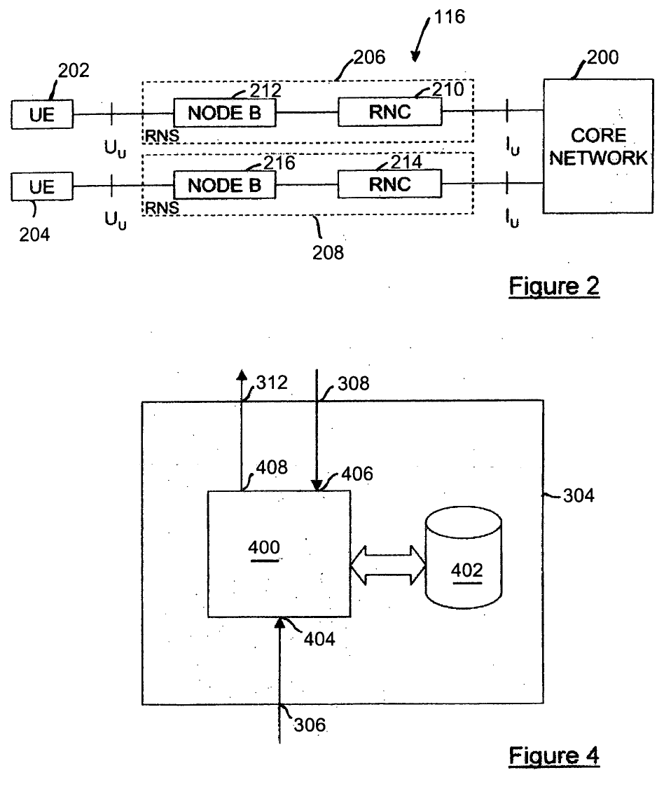

Turning to the first embodiment (FIG. 2), the UTRAN 116 is coupled to the IP backbone network 102 via the SGSN 114, the IP backbone network 102 and the SGSN 114 constituting a part of a core network 200. The core network 200 communicates with the UTRAN 116 via a first interface I_{U}. A first User Equipment (UE) unit 202 and a second UE unit 204 are capable of communicating with the core network 200 via the UTRAN 116. The first and second UE units 202, 204 are capable of communicating with the UTRAN 116 via a Radio Frequency (RF) interface U_{U}. In accordance with the UMTS standard, the UTRAN 116 supports a Time Division-Code Division Multiple Access (TD-CDMA) multiple access scheme using a Time Division Duplexing (TDD) technique, and a Wideband-Code Division Multiple Access (W-CDMA) multiple access scheme using a Frequency Division Duplexing (FDD) technique.

The core network 200, the UTRAN 116 and the first and second UE units 202, 204 provide an access stratum (not shown) and a non-access stratus (not shown).

The UTRAN 116 comprises a first Radio Network Subsystem (RNS) 206 and a second RNS 208, the first and second RNSs 206, 208 being capable of communicating with the core network 200. The first RNS 206 is also capable of communicating with the first UE unit 202, the second RNS 208 being capable of communicating with the second UE unit 204.

The first RNS 206 comprises a first Radio Network Controller (RNC) 210 capable of communicating with the core network 200 and coupled to a first Node B 212, the first Node B 212 being capable of communicating with the first UE unit 202. The second RNS 208 comprises a second RNC 214 capable of communicating with the core network 200 and coupled to a second Node B 216, the second Node B 216 being capable of communicating with the second UE unit 204.

The first and second UE units 202, 204 are, in this example, multimedia mobile terminals capable of downloading Internet-based content, such as web pages, multimedia content, as well as receiving and sending e-mail. Of course, other terminal configurations can be employed, for example a mobile terminal coupled to a mobile computing device, such as a laptop computer or a Personal Digital Assistant (PDA). Alternatively, one or both of the UE units 202, 204 can be any other type of terminal capable of operating in accordance with the UMTS standard and supporting web browsing and/or e-mail functionality.

Referring back to FIG. 1, the probe 134 is part of an acceSS7 network monitoring system (not shown) supplied by Agilent Technologies, Inc. that monitors performance at predetermined points in the communications network 100. In this example, the predetermined points are the points of connection of the first, second and fifth taps 136, 138, 144. Referring to FIG. 3, a malicious traffic monitoring system 300 is coupled to acceSS7 system in order to receive so-called Service Usage Record (SUR) feeds 302. In order to provide the SUR feeds 302, the acceSS7 system has an Internet Protocol (IP) SUR generation system (not shown) that resides in the probe 134. However, any suitable functional entity can be employed that is capable of identifying the nature of flows of IP packets.

The attack monitoring system 300 comprises a pattern matching engine 304 having a first input 306 capable of receiving the SUR feeds 302. A second input 308 of the pattern matching engine 304 is coupled to a configuration system 310. An output 312 of the pattern matching engine 304 is coupled to network Operations Support Systems (OSS) 314. Additionally, the pattern matching engine 304 is coupled to a data storage device 305.

Whilst, in this example, the attack/malicious traffic monitoring system 300 is separate from the acceSS7 network monitoring system, but in communication with the acceSS7 system so as to receive the SUR feeds 302 from the acceSS7 system, it should be appreciated that the attack monitoring system 300 can be integrated into the acceSS7 system.

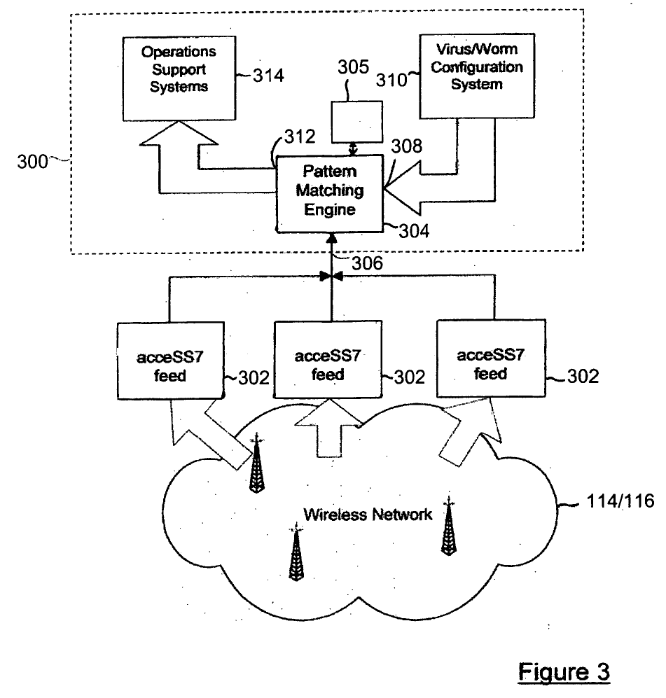

Turning to FIG. 4, the pattern matching engine 304 comprises a processing resource, for example a microprocessor 400, coupled to a storage device, for example a hard disc drive, storing a database 402. The microprocessor 400 has a first input 404 coupled to the first input 306 for receiving the SUR feeds 302. A second input 406 of the microprocessor 400 is coupled to the second input 308 and an output 408 of the microprocessor 400 is coupled to the output 312.

Whilst the above apparatus has been described in the context of the use of the probe 134, this should be seen as purely exemplary and it should be appreciated that the necessary monitoring functionality can be provided by other entities in the communications network 100, for example, the SGSN 114, one of the first or second RNCs 210, 214 or the first or second Node Bs 212, 216.

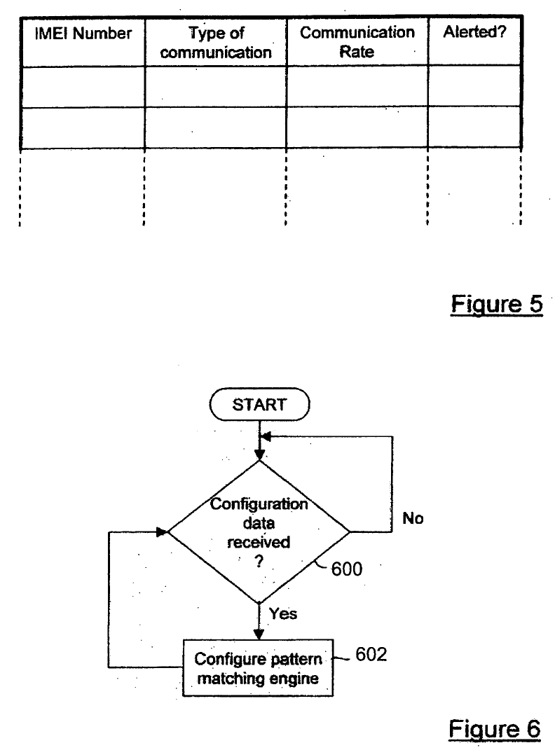

In operation (FIG. 6), the configuration system 310 transmits configuration data to the pattern matching engine 304 as a data file containing information concerning, for example, patterns to be observed and thresholds, such as suspicious or maximum packet sizes. This first pattern matching process can, be implemented, for example, as a table and/or rules based process. The pattern matching engine 304 awaits (Step 600) the configuration data. Upon receipt of the configuration data, the pattern matching engine 304 installs (Step 602) the configuration data, thereby configuring itself. Re-configuration of the pattern matching engine 304 takes place in the same way as described herein in relation to FIG. 6, as and when required.

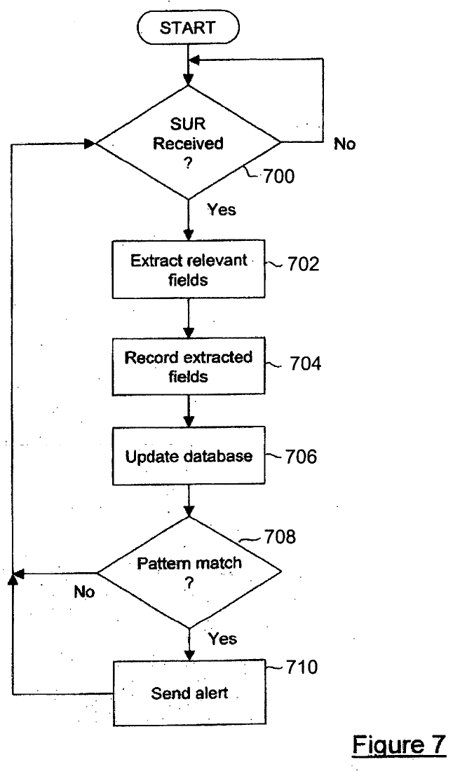

After configuration (FIG. 7), the pattern matching engine 304 awaits (Step 700) receipt of an SUR from one of the SUR feeds 302. The SUR feeds 302 are provided by the IP SUR generation system, which reports usage of IP packet data in wireless communications networks. In the present example, the IP SUR generation system selects information about data “tunnels” established using a GPRS Tunnelling Protocol (GPT) as well as protocol messages that are communicated on the first, second and third links 115, 118, 122, by monitoring IPv4 packets on a so-called “Gₙ interface” and selecting IP traffic, for example, User Datagram Protocol (UDP) traffic or Transmission Control Protocol/Internet Protocol (TCP/IP) traffic with a pre-specified source and destination port number.

From the SURs received, the pattern matching engine 304 extracts (Step 702) fields relevant for the purposes of identifying one or more traffic pattern that corresponds to “malicious traffic”. Malicious traffic is herein defined as traffic corresponding to a malicious attack, for example a virus or a worm. In this example, the pattern matching engine 304 stores (Step 704) the extracted fields in the database 402. Referring to FIG. 5, a first pattern matching process uses a table to log, for each mobile terminal IMSI (International Mobile Subscriber Identifier) number, types of traffic, for example e-mail traffic, the rate at which the type of traffic is being sent and whether or not an alert message has been generated in the event that the pattern matching engine believes the traffic detected is malicious traffic. The table is stored in the database 402, the database 402 being stored by the data storage device 305 for access by the pattern matching engine 304.

After storage of the data from extracted fields of a given received SUR, the rate at which the type of traffic identified is being sent, from the IMSI number identified by the given SUR, is recalculated and the database 402 updated (Step 706). Once the rate at which the type of traffic identified is being sent has been recalculated, it is compared (Step 708) with a threshold value (not shown). If the rate does not exceed the threshold value, the pattern matching engine 304 continues with the processing of the received SURs. If, however, the rate exceeds the threshold value, the rate of traffic is deemed to be indicative of malicious traffic, for example a virus spread by e-mail if the type of traffic identified is e-mail traffic. In such circumstances, the pattern matching engine 304 generates and sends (Step 710) a message containing an indication of the type of traffic detected and the IMSI number of a mobile terminal identified as being associated with the type of traffic detected.

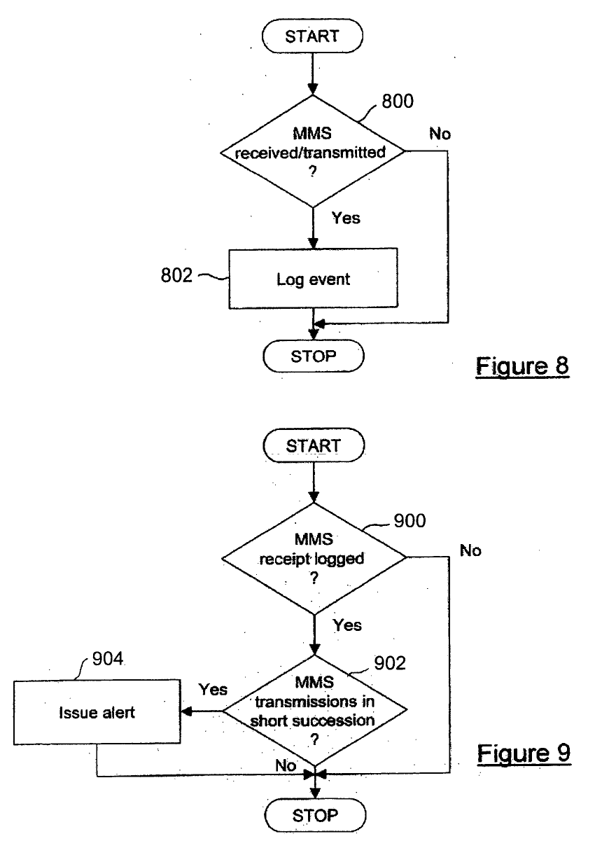

Turning to FIG. 8, a second pattern matching process attempts to identify worms, and can be implemented, for example, as a table and/or rules based process. For example, a table based process can employ a table comprising a list of packet sizes and frequencies of occurrences for each packet size listed. Similarly, a rules based process can employ a series of rules that result in decisions on the basis of packet sizes and frequencies of occurrences per packet size. Since it is known that certain types of worms try to exploit a security weaknesses in a Multimedia Messaging Service (MMS) subsystem of a mobile terminal, the pattern matching engine 304 monitors SURs received to identify (Step 800) traffic relating to an MMS message that is either illegally sized or a known size indicative of the MMS message containing a known worm. If it is determined that an MMS message containing a worm is being received, the pattern matching engine 304 logs (Step 802) the suspected receipt of the worm against an entry in the database 402 corresponding to an IMSI of a mobile terminal that has received the MMS message. Thereafter, or if the received MMS message detected does not fulfil the above size criterion, this process re-starts to detect new received MMS messages.

A separate process (FIG. 9) monitors transmission of MMS messages. When transmission of an MMS message from a mobile terminal has been detected, the pattern matching engine 304 firstly determines (Step 900) if the database 402 contains a receipt entry for the IMSI of the mobile terminal transmitting the MMS message. If the receipt entry exists, i.e. an entry indicating that an MMS message suspected of containing a worm has been received by the mobile terminal of the IMSI number, the pattern matching engine 304 determines (Step 902) if the detected transmitted MMS message, together with any previously transmitted MMS messages by the mobile terminal of the same IMSI number, constitutes an excessive number of MMS message transmissions in short succession. The transmission in short succession of a number of MMS messages by a mobile terminal after receipt of an MMS message strongly suspected of carrying a worm is deemed indicative of the worm trying to proliferate itself and so the pattern matching engine 304 generates and sends (Step 904) a message containing an indication of the type of traffic detected and the IMSI number of the mobile terminal associated with the type of traffic detected. Otherwise, if the mobile terminal of the IMSI number has not been noted as having received an MMS message suspected of containing a worm or the MMS messages transmitted are not deemed to be in short succession then the process terminates and restarts upon detection of transmission of another MMS message.

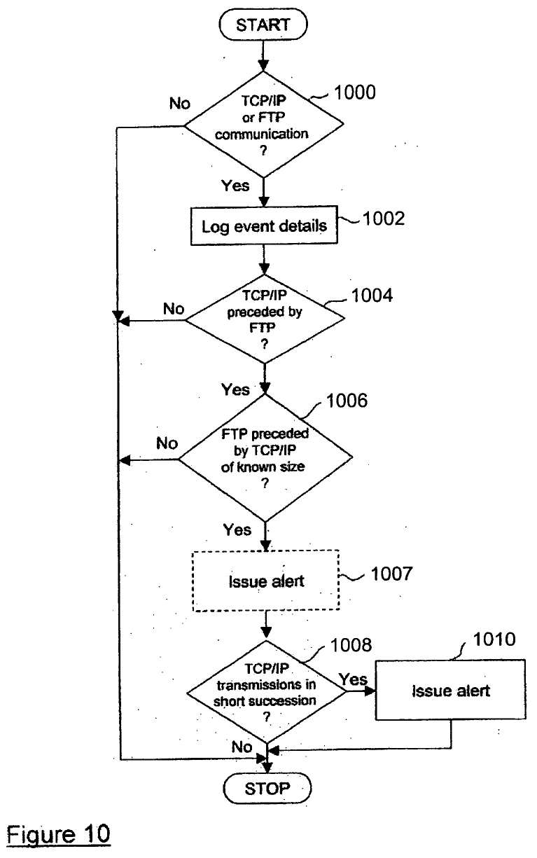

Referring to FIG. 10, a third pattern matching process relates to the detection of worms that only propagate a small executable file that subsequently downloads a larger executable file, and can be implemented, for example, as a table and/or rules based process. In order to detect such worms, the pattern matching engine 304 monitors the received SURs to identify (Step 1000) Transmission Control Protocol (TCP)/Internet Protocol (IP) packets or File Transfer Protocol (FTP) packets. Upon detection of a TCP/IP or FTP packet, the pattern matching engine records (Step 1002) details relating to the TCP/IP or FTP packet. Thereafter, the pattern matching engine 304 searches the database 402 to determine (Step 1004), if the packet associated with the received SUR is a TCP/IP packet, whether receipt of the TCP/IP packet by a mobile terminal having a same IMSI number was preceded by an FTP packet or a stream of FTP packets. If no FTP session is identified, then this process terminates and re-starts in relation to a new TCP/IP or FTP communication. Otherwise, the pattern matching engine 304 then proceeds to determine (Step 1006) if the FTP session was proceeded by receipt, by the mobile terminal of the same IMSI number, of an earlier TCP/IP packet. If no earlier TCP/IP packet preceded the FTP session for the mobile terminal of the same IMSI number, this process terminates and re-starts in relation to a new TCP/IP or FTP communication.

Otherwise, before detection of a further indicator, the detection by the pattern matching engine 304 of earlier TCP/IP packets can be construed as indicative of a malicious attack being in progress and the pattern matching engine 304 generates and sends (Step 1007) a message containing an indication of the type of traffic detected, i.e. the worm and the type of worm, and the IMSI number of the mobile terminal associated with the type of traffic detected. However, the choice of whether or not to issue the message at this stage before detection of the further indicator of the malicious attack is dependent upon the malicious attack detection policy implemented by a network operator. In this respect, a given network operator may be more tolerant than other network operators of so-called “false positive” detections of malicious attacks, in which case early issue of alerts in the form of the message is an acceptable practice. Otherwise, the step of early issuance of the message (Step 1007) can be skipped. After sending the message, or if not implemented due to the network operator wishing to detect the further indication of the malicious attack, the pattern matching engine 304 determines (Step 1008) if any subsequently received SURs correspond to TCP/IP packets transmitted by the mobile terminal of the same IMSI number in short succession. If this is the case, a worm is deemed to have been received by the mobile terminal of the same IMSI number and the worm is attempting to propagate and proliferate itself. Consequently, the pattern matching engine 304 generates and sends (Step 1010) a message containing an indication of the type of traffic detected, i.e. the worm and the type of worm, and the IMSI number of the mobile terminal associated with the type of traffic detected.

Whist the above described processes relate to detection of particular types of malicious traffic, it should be understood that malicious traffic can exist in a number of other different forms. In addition to e-mail, viruses can be propagated via other IP packets, such as TCP or UDP packets, which are used by mobile terminals, for example for HTTP/NAP communications or Microsoft Outlook calendar synchronisation. Typically, these means of propagation contain illegal packets that are not properly handled by an Operating System (OS) of a given mobile terminal, allowing the contents of the packets to over-write memory, usually with some executable code.

As mentioned above, in order to identify traffic flows, the pattern matching engine 304 makes use of SUR feeds. These feeds, as also described above, provide the pattern matching engine 304 with SURs for analysis. In this respect, the following SUR fields can be used to assist in the determination of the type of traffic being transmitted and/or received.

In relation to tunnels created by mobile terminals using a GPT protocol and the data carried within the tunnels, Table 1 below shows a number of the fields from a GPT tunnel data SUR that can be used. It is not essential to use all of the number of fields.

TABLE 1

| Field Name | Details |
|---|---|
| IMSI | IMSI of mobile terminal attached to tunnel |
| Source IP Address | The source IP address of the tunnel. This will |
| | typically be the SGSN. |
| Destination IP | The destination IP address of the tunnel. This will |
| Address | typically be the GGSN IP interface on the Gₙ link. |
| Uplink Bytes | Count of GTP payload bytes in the uplink direction. |
| Transferred | |
| Downlink Bytes | Count of GTP payload bytes in the downlink |
| Transferred | direction. |
| Start Time | Tunnel creation time. |
| Unexpected | GTP message with a message type not recognised. |
| Messages | |

In relation to transport data, Table 2 below shows a number of the fields from a transport data SUR that can be used. It is not essential to use all of the number of fields.

TABLE 2

| Field Name | Details |
|---|---|
| Uplink IP Address | IP version v4 address used in the uplink direction. |
| Downlink IP Address | IP version v4 address used in the downlink direction. |
| | This will typically be the IP address used from the MS. |
| Uplink Port | TCP or UDP port number. |
| | (For well known ports see |
| | http://www.iana.org/assignments/port-numbers) |
| | For other protocols the port number will be 0 |
| Downlink Port | TCP or UDP port number. |
| | (For well known ports see |
| | http://www.iana.org/assignments/port-numbers) |
| | For other protocols the port number will be 0 |
| IP Protocol | The protocol indication from IP, this will commonly be ICMP, |
| | TCP, UDP etc. (For possible values see |
| | http://www.iana.org/assignments/protocol-numbers) |
| Uplink Type of Service | TOS field from the IP header. |
| Downlink Type of Service | TOS field from the IP header. |
| Uplink Total Packet Count | Number of packets (other than GTP signalling |
| | messages) in the uplink direction (i.e. includes |
| | overhead of TCP setup, etc) |
| Uplink Data Packet Count | Number of user data packets, excluding e.g. TCP |
| | signalling setup messages, in the uplink direction |
| Uplink Total User Data | Total size of payload (of packets other than GTP |
| Bytes | signalling messages) in the uplink direction that |
| | carry user data. |
| Downlink Total Packet | Number of packets (other than GTP signalling |
| Count | messages) in the downlink direction (i.e. includes |
| | overhead of TCP setup, etc) |
| Downlink Data Packet | Number of user data packets, excluding e.g. TCP |
| Count | signalling setup messages, in the downlink direction. |
| Downlink Total User Data | Total size of payload (of packets other than GTP |
| bytes | signalling messages) in the downlink direction that |
| | carry user data. |
| Uplink Anomalous Packets | A count of packets considered as anomalies in the |
| | uplink direction. |
| | For all transports a duplicate packet is considered an |
| | anomaly. In addition for TCP packets delivered Out |
| | of Sequence are also counted. |
| Downlink Anomalous | A count of packets considered as anomalies in the |
| Packets | downlink direction. |
| | For all transports a duplicate packet is considered an |
| | anomaly. In addition for TCP packets delivered Out |
| | of Sequence are also counted. |
| Uplink Anomalous Bytes | Total of payload bytes contained in packets, which |
| | are considered as anomalies in the uplink direction. |
| | For all transports a retransmitted packed is |
| | considered an anomaly. In addition for TCP packets |
| | delivered Out of Sequence are also counted. |
| Downlink Anomalous Bytes | Total of payload bytes contained in packets, which |
| | are considered as anomalies in the downlink |
| | direction. |
| | For all transports a retransmitted packed is |
| | considered an anomaly. In addition for TCP packets |
| | delivered Out of Sequence are also counted. |
| Uplink Active Seconds | Number of Active seconds in the uplink direction. |
| Downlink Active Seconds | Number of Active seconds in the downlink direction. |
| Start Time | Start Time of transport within the tunnel |
| Response Time | Time of first response packet within the tunnel |
| End Time | End Time of transport within the tunnel or the time of |
| | the last activity. |

In relation to service data, Table 3 below shows a number of the fields from an HTTP Protocol SUR that can be used. It is not essential to use all of the number of fields.

TABLE 3

| Field Name | Details |
|---|---|
| Service Status Code | Listed in RFC2616, section 10 (www.faqs.org/rfcs/). |
| Service Status | Service/protocol status message |
| Message | |
| Start Time | Time of first application message |
| Response Time | Time of first return message |
| Last Time | Time of last message |
| HTTP Method | Transfer method, Values: |
| | Get, Head, Put, Post, Connect, Delete, Trace, |
| | Options |
| HTTP URI | URI of the first HTTP Request observed |

Further, Table 4 below shows a number of the fields from a WSP Protocol SUR that can be used. It is not essential to use all of the number of fields.

TABLE 4

| Field Name | Details |
|---|---|
| Service Status Code | Value complying with RFC2616 ranges |
| Service Status | Service/protocol status message |
| Message | |
| Start Time | Time of first application message |
| Response Time | Time of first return message |
| Last Time | Time of last message |
| WSP Content Type | The type of data being passed. (For full listings see |
| | http://www.wapforum.org/wina/wsp-content- |
| | type.htm) |
| WSP URL | The WAP URL |
| WSP Method | Transfer method |
| WSP User Agent | An indication of the device carrying out the transfer. |

Table 5 below shows a number of the fields from a POP3 Protocol SUR that can be used. It is not essential to use all of the number of fields.

TABLE 5

| Field Name | Details |
|---|---|
| Service Status Code | Value complying with RFC2616 ranges. 2xx |
| | for success 4xx for failure. |
| Service Status Message | Service/protocol status message |
| Start Time | Time of first application message |
| Response Time | Time of first return message |
| Last Time | Time of last message |
| POP3 Max Item Size | Size of the largest item size downloaded (bytes) |
| POP3 Total Item Size | Total data downloaded in session (bytes) |

Table 6 below shows a number of the fields from an SMTP Protocol SUR that can be used. It is not essential to use all of the number of fields.

TABLE 6

| Field Name | Details |
|---|---|
| Service Status Code | Value complying with RFC2616 ranges. 2xx |
| | for success 4xx for failure. |
| Service Status Message | Service/protocol status message |
| Start Time | Time of first application message |
| Response Time | Time of first return message |
| Last Time | Time of last message |
| SMTP Transfer Direction | Indicates direction of transfer for session. |
| SMTP Max Item Size | Size of the largest item size downloaded (bytes) |
| SMTP Total Item Size | Total data downloaded in session (bytes) |

Table 7 below shows a number of the fields from an ICMP Service SUR that can be used. It is not essential to use all of the number of fields.

TABLE 7

| Field Name | Details |
|---|---|
| Service Status Code | Value complying with RFC2616 ranges. 2xx for |
| | success 4xx for failure. |
| Service Status | Service/protocol status message |
| Message | |
| Start Time | Time of first application message |
| Response Time | Time of first return message |
| Last Time | Time of last message |
| ICMP Method | ICMP service type |
| | Values: Echo, Destination unreachable, Source |
| | Quench, Redirect, Timestamp, Router discovery, |
| | Time exceeded, Parameter problem, Information, |
| | Address mask discovery. |
| ICMP Source IP | IP Source address returned in the ICMP message |
| Address | |
| ICMP Destination IP | IP Destination address returned in the ICMP |
| Address | message. |

Table 8 below shows a number of the fields from a Service with no Content Analysis SUR that can be used. It is not essential to use all of the number of fields.

TABLE 8

| Field Name | Details |
|---|---|
| Service Status Code | Service/protocol summary or return code |
| Service Status | Value complying with RFC2616 ranges. 2xx for |
| Message | success 4xx for failure. |
| Start Time | Time of first application message |
| Response Time | Time of first return message |
| Last Time | Time of last message |

In the second embodiment, malicious traffic is communicated to and from mobile terminals via the GERAN 120. Since the structure and operation of the GERAN 120 is known, they will not be described in any further detail. Indeed, monitoring of the malicious traffic is common to the technique described above, because the probe 134 is coupled to links connected to the SGSN 114, the SGSN 114 being coupled to both the UTRAN 116 and the GERAN 120. Consequently, the SUR feeds are generated in respect of the similar links being monitored.

In relation to the above-mentioned embodiments, the OSS 314 receives alert messages from the pattern matching engine 312 upon detection of malicious traffic. The messages, as described above, contain details associated with the malicious traffic, for example the type of malicious traffic, for example, virus or worm traffic, and the exact variant of the type of malicious traffic, for example the so-called “W32.Bugbear@mm” worm. In addition, the IMSI number of the mobile terminal involved in the receipt and/or propagation of the worm is included in the alert messages.

Upon receipt of an alert message form the pattern matching engine 304, the OSS 314 implements a counter-measure to neutralise or halt the spread of the malicious traffic. The OSS 314 has a database (not shown) of software applications and/or patches to prevent the spread of malicious traffic. In one example, the OSS 314 looks-up the variant of the virus or worm and identifies a software patch and/or an application to remove a virus or a worm. The OSS 314 then sends the software patch and/or the application to remove the virus or worm to the mobile terminal having the IMSI number identified in the alert message. The mobile terminal then prompts the user of the mobile terminal to install the patch and/or application to remove and/or prevent further spread of the virus or the worm.

Alternatively, if the patch and/or application cannot be found in the database of the OSS 314, the OSS 314 instructs the communications network to withhold service or disconnect the mobile terminal of the IMSI number identified in the alert message from the UTRAN 116 or GERAN 120 until further notice. Just prior to disconnection/withholding of service, a message can be communicated to the mobile terminal of the IMSI number identified, the message being displayed or played to the user of the mobile terminal to advise them, for example, of the reason for disconnection or withholding of service. Of course, if desired, instead of trying to identify remedies for viruses or worms, the above measure of disconnection can be implemented as another or an only counter-measure.

As an alternative to complete disconnection of the mobile terminal from the UTRAN 116 or the GERAN 120, as applicable, partial service can be withheld or disconnected, for example data services only, leaving other services available to the user of the mobile terminal, such as voice services; this would enable the mobile terminal still to be of use in emergency situations. Further, withholding or disconnection of data services can be further refined by withholding or disconnecting only certain data services, for example one or more of a HyperText Transfer Protocol (HTTP) service, a Simple Mail Transport Protocol (SMTP) and/or an Internet Message Access Protocol (IMAP).

In relation to the MSC 124, a malicious network attacker can attempt to launch a malicious attack involving successive establishment of calls to different mobile terminals in order to play a recorded sound file containing, for example, a verbally abusive message. In order to detect such attacks, the above apparatus is suitably adapted to process Call Detail Records (CDRs) instead of or as well as SURs relating to data services. Indeed any call data derived from signalling data can additionally or alternatively be used by the pattern matching engine 304 to detect (and subsequently act upon) such malicious attacks. To achieve this additional monitoring functionality, the fourth and fifth links 126, 128 are monitored by the probe 134 via the third and fourth taps 140, 142.

Although, in the above examples, references are made to the IMSI number, it should be appreciated that, subject to data availability, the IMEI (International Mobile Equipment Identity) number can be used. It should also be noted that patterns can be dynamically loaded at predetermined intervals in order to maintain reliable operation of the pattern matching engine to combat new malicious attacks as they evolve or appear.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

1. A network monitoring apparatus for detecting malicious traffic in a communications network, the apparatus comprising:
an input for receiving service usage data derived, when in use, from signalling data, the signalling data originating, when in use, from a monitored signalling link; and
a data store for storing the service usage data; and
a processing resource to support a pattern matching engine for using a number of the stored data to identify, when in use, traffic patterns communicated to and/or from a communications terminal indicative of malicious traffic.

2. An apparatus as claimed in claim 1, wherein the service usage data is a feed of Service Usage Records (SURs).

3. An apparatus as claimed in claim 1, wherein the data stored from the at least one field of received usage records is stored as a database for serving as a resource for the identification of the traffic patterns.

4. An apparatus as claimed in claim 1, wherein the identification of the traffic patterns includes analysing a property of at least one field of at least one of the usage records.

5. An apparatus as claimed in claim 1, wherein the malicious traffic corresponds to a virus.

6. An apparatus as claimed in claim 1, wherein the malicious traffic corresponds to a worm.

7. An apparatus as claimed in claim 1, wherein the processing resource is arranged to generate, when in use, a message to indicate that malicious traffic has been detected.

8. An apparatus as claimed in claim 7, wherein the malicious traffic corresponds to a type of malicious attack, the message identifying the type of the malicious attack.

9. An apparatus as claimed in claim 7, wherein a counter-measure is communicated, when in use, to the communications terminal in response to the message.

10. An apparatus as claimed in claim 7, wherein a counter-measure is initiated in relation to the communications terminal in response to the message.

11. An apparatus as claimed in claim 10, wherein the counter-measure is prevention of the communications terminal from using one or more service supported by the communications network associated with the mobile terminal to communicate data.

12. A network monitoring system including the network monitoring apparatus as claimed in claim 1.

13. A communications network comprising the apparatus as claimed in claim 1.

14. A communications network as claimed in claim 11, further comprising a counter-measure service station for managing the deployment of the counter-measures.

15. A method of detecting malicious traffic in a communications network, the method comprising:
receiving a feed of service usage data derived from signalling data, the signalling data originating from a monitored signalling link;
storing service usage data; and
using a number of the stored data to identify traffic patterns communicated to and/or from a communications terminal indicative of malicious traffic.

16. A computer program element comprising computer program code means to make a computer execute the method as claimed in claim 15.

17. A computer program element as claimed in claim 16, embodied on a computer readable medium.

18. A use of a communications network monitoring system to detect communications to and/or from wireless terminals indicative of a malicious attack.
